(19) United States
(12) Patent Application Publication
(10) Pub. No.: US 2021/0262465 A1
(43) Pub. Date: Aug. 26, 2021

(54) ROTARY POSITIVE DISPLACEMENT PUMPS

(71) Applicant: APPLIED NANO SURFACES SWEDEN AB, Uppsala (SE)

(72) Inventors: Johan BLOMKVIST, Uppsala (SE); Christian KOLAR, Stockholm (SE); Clemens VERPOORT, Monheim am Rhein (DE); Boris ZHMUD, Skogås (SE)

(73) Assignee: APPLIED NANO SURFACES SWEDEN AB, Uppsala (SE)

(21) Appl. No.: 17/251,304

(22) PCT Filed: Jun. 13, 2018
(86) PCT No.: PCT/SE2018/050618

§ 371 Date: Dec. 11, 2020

(51) Int. Cl. F04C 2/16; F04C 2/10

(52) U.S. Cl. CPC F04C 2/16; F04C 2/102; F04C 2240/30; F05C 2203/083; F04C 2230/91

(57) ABSTRACT

A rotary positive displacement pump (1) comprises a pump enclosure (10) and at least one rotating member (20). The pump enclosure (10) has an inlet (12) and an outlet (14). The rotating member (20) is arranged for, when being rotated, causing a transfer of a liquid from the inlet (12) to the outlet (14). The rotary positive displacement pump (1) has internal sliding surfaces (16, 24, 26, 32, 34) that during operation are exposed to the liquid and are exposed to a sliding contact relative to other internal sliding surfaces (16, 24, 26, 32, 34) of the rotary positive displacement pump (1). At least a part of the internal sliding surfaces (16, 24, 26, 32, 34) has a surface region composed by a nitrided or nitrocarburized steel intercalated with a solid lubricant. A method for manufacturing a rotary positive displacement pump is also disclosed.

### TECHNICAL FIELD

The present disclosure is in general related to pumps and manufacturing thereof, and in particular to rotary positive displacement pumps.

### BACKGROUND

A rotary vane pump was invented by Charles C. Barnes more than a century ago and was patented in 1874. A typical vane pump comprises a cylindrical rotor with slots, in which vanes are moving. The rotor is placed in a cylindrical housing in an off-centered fashion. The vanes are urged out from the slots, typically by means of springs and interacts mechanically with the inner surface of the cylindrical housing in such a way that suction and pumping are induced when the rotor spins.

Rotary vane pumps are a preferred type of engine oil pump or for other liquids having a relatively low viscosity. Vane pumps available on the market today can deliver flow rates from 10 to 10 000 l/min and a total pressure head of 1 to 20 Bar.

During operation of a rotary vane pump, the vanes slide out and in within the slots and both the vanes and the slots may suffer from wear. Also to rotor itself, also typically in close contact with the inner surface of the cylindrical housing may suffer from wear. This may cause premature pump failure. This problem is also typically significantly increased when the vane pump pumps soot-contaminated oils. The soot content thus seems to increase the wear of the parts in sliding contact with each other.

Ironically, the introduction of Exhaust Gas Recirculation (EGR) in modern diesel engines as a measure to limit harmful NOx emissions, together with the use of low-SAPS oil (Sulfated Ash, Phosphorus and Sulfur) to achieve better compatibility to Diesel Particulate Filters (DPF), may lead to higher levels of soot contamination under certain driving conditions, including short haul driving and urban driving. In some extreme cases, e.g. in urban taxis, over 5% soot and over 25% fuel dilution was measured. Standard mid-SAPS motor oils (ACEA C2, C3 and C5) can with confidence handle up to maximum 2% soot. This limit is even lower for low-SAPS oils (ACEA C1 and C4). Modern low-viscosity motor oils are also quite sensitive to fuel dilution, often falling out-of-grade already at as little as 5% fuel dilution.

Known solutions to alleviate the abovementioned wear issues are the use of special alloyed materials for rotor and vanes, the use of heat-treated parts, including gas nitrided or nitrocarburized vanes, and/or the use of hard coatings, such as Diamond-Like Coatings (DLC), on the vanes and/or the rotor. Higher surface hardness and exceptional abrasion resistance of DLC coated parts as compared to case hardened ones makes DLC and other hard coatings the preferred choice in those applications where high abrasive stresses are anticipated. Hence, it comes as a no surprise that DLC coatings have been used for treatment of vanes and gears for rotary oil pumps. Some non-exclusive examples may be found in the published US patent application US 2009/0208357 or the U.S. Pat. No. 6,629,829, 8,770,955 or 5,672,054, applied to rotary vane pumps or other types of rotary positive displacement pumps. However, it turned out that DLC-coated vanes perform rather poorly when soot-contaminated oils are used. Also, the other known solutions of use of heat-treated parts is not fully satisfactory either at high soot levels.

There is therefore still a need for an improved wear resistance on vanes and rotors, in particular in the presence of soot.

### SUMMARY

A general object is to achieve pumps with improved wear characteristics when pumping oils comprising non-negligible levels of soot.

The above object is achieved by methods and devices according to the independent claims. Preferred embodiments are defined in dependent claims.

In general words, in a first aspect, a rotary positive displacement pump comprises a pump enclosure and at least one rotating member. The pump enclosure has an inlet and an outlet. The rotating member is arranged for, when being rotated, causing a transfer of a liquid from the inlet to the outlet. The rotary positive displacement pump has internal sliding surfaces that during operation are exposed to the liquid and are exposed to a sliding contact relative to other internal sliding surfaces of the rotary positive displacement pump. At least a part of the internal sliding surfaces has a surface region composed by a nitrided or nitrocarburized steel intercalated with a solid lubricant.

In a second aspect, a method for manufacturing a rotary positive displacement pump comprises providing of parts having internal sliding surfaces. At least one rotating member is mounted in a pump enclosure. The pump enclosure has an inlet and an outlet. The rotating member is arranged for, when being rotated, causing a transfer of a liquid from the inlet to the outlet. The parts having the internal sliding surfaces are arranged to during operation being exposed to the liquid and being exposed to a sliding contact relative to other internal sliding surfaces of the rotary positive displacement pump. At least a part of the internal sliding surfaces is treated to achieve a surface region composed by a nitrided or nitrocarburized steel intercalated with a solid lubricant.

One advantage with the proposed technology is that the wear, in presence of soot, is reduced. Other advantages will be appreciated when reading the detailed description.

### BRIEF DESCRIPTION OF THE DRAWINGS

The invention, together with further objects and advantages thereof, may best be understood by making reference to the following description taken together with the accompanying drawings, in which:

FIG. 1 illustrates one embodiment of a rotary vane pump;

FIG. 2 illustrates one embodiment of a rotary screw pump;

FIG. 3 illustrates one embodiment of a rotary external gear pump;

FIG. 4 illustrates one embodiment of a rotary internal gear pump;

FIG. 5 is a diagram illustrating an example of a wear process of nitrided vanes in a soot-contaminated ACEA C5 motor oil;

FIG. 6 is a flow diagram of steps of an embodiment of a method for manufacturing a rotary positive displacement pump;

FIG. 7 is a diagram illustrating an example of a wear process of TriboNite® vanes in a soot-contaminated ACEA C5 motor oil;

FIG. 8 is a flow diagram illustrating an embodiment of a method for manufacturing a rotary positive displacement pump; and

FIG. 9 is a flow diagram illustrating an embodiment of a method for manufacturing a rotary positive displacement pump.

### DETAILED DESCRIPTION

Throughout the drawings, the same reference numbers are used for similar or corresponding elements.

For a better understanding of the proposed technology, it may be useful to begin with a brief overview of positive displacement pumps. A general positive displacement pump operates by trapping a fixed amount of a fluid, provided through an inlet. By moving at least one of the parts that are used for trapping, the trapped amount of fluid is displaced to an outlet. In some designs, a cavity expands at the inlet side, thereby using suction of the fluid into the cavity. At the discharge side, the cavity volume is decreased and pushes the fluid out through the outlet.

An advantage in certain applications is that positive displacement pumps are constant flow machines. This means that they give rise to the same flow of fluid at a given speed independently of the discharge pressure, if internal leakage is neglected.

One category of positive displacement pumps is rotary positive displacement pumps. A pump enclosure has an inlet and an outlet. At least one rotating part, such as e.g. a screw, a gear or a disc with vanes, is arranged for causing a displacement or transfer of a liquid from the inlet to the outlet when the rotating part is rotated. The rotary positive displacement pump thus have parts having internal sliding surfaces. These sliding surfaces are arranged to being exposed to the pumped liquid during operation. They are also arranged to be exposed to a sliding contact relative to other internal sliding surfaces of the rotary positive displacement pump during operation. In other words, a rotary positive displacement pump uses a rotating mechanism that creates an underpressure that captures and draws in the liquid from the inlet into a cavity and that creates an overpressure the drains the cavity and pushes out the liquid to the outlet.

One advantage with rotary positive displacement pumps is that they remove air from the fluid during the pumping action. This means that the pumping becomes very efficient and that there is no need for any additional venting devices.

A general drawback is that the rotary positive displacement pumps are using very close tolerances between the above described sliding surfaces to achieve the pumping effect. The rotating speed is therefore typically relatively low in order to avoid erosion of the sliding surfaces. However, also contamination or particles in the fluid, such as e.g. soot in an oil, may cause wear on the sliding surfaces. Wear on the sliding surfaces will result in that the close tolerances deteriorate and the pumping efficiency decreases.

One type of rotary positive displacement pumps are rotary vane pumps. A rotary vane pump comprises vanes mounted to a rotor or rotating member that rotates within the pump enclosure. The rotary vane pump comprises at least one vane arranged to enable sliding against an internal surface of said pump enclosure. In a typical design, the vane(s) is also arranged to enable sliding against the rotating member, typically within a slit in the rotating member.

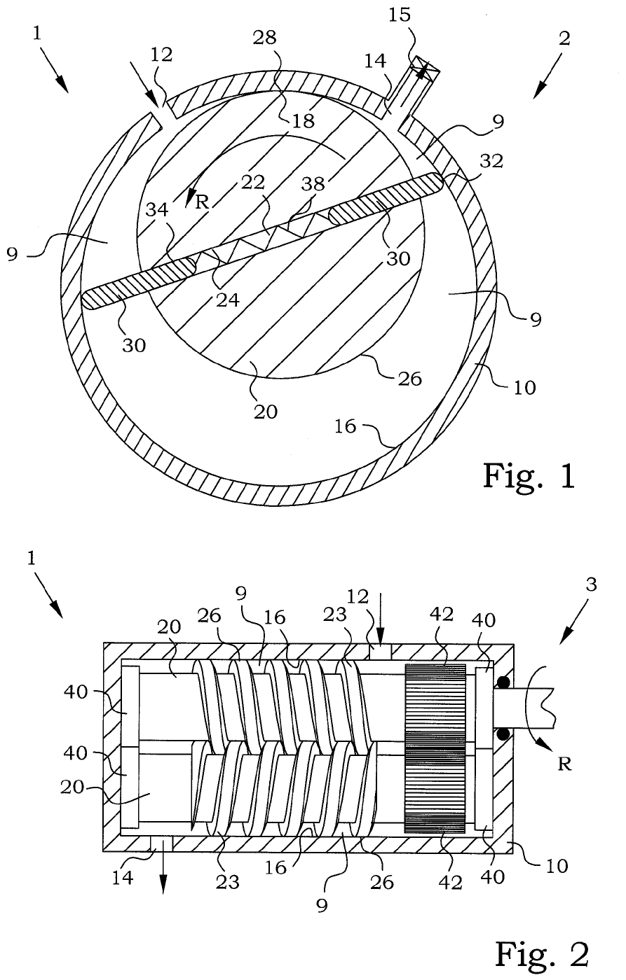

FIG. 1 illustrates one embodiment of a rotary vane pump 2, i.e. one type of a rotary positive displacement pump 1. The rotary vane pump 2 comprises a pump enclosure 10, having an inlet 12 and an outlet 14. The outlet 14 is here provided with check valve 15 to obstruct back-flow into the rotary vane pump 2. The rotary vane pump 2 further comprises one rotating member 20, in this embodiment a cylindrical body. The rotating member 20 is rotatable around an axis displaced from the center of the pump enclosure 10. At each instant, one point 28 on the rotating member 20 is in contact with one point 18 of the internal surface 16 of the pump enclosure 10.

The rotary vane pump 2 further comprises vanes 30, arranged to enable sliding against the rotating member 20 and the internal surface 16 of the pump enclosure 10. The vanes 30 are situated within slots 22 in the rotating member 20. In this embodiment, a spring 38 pushes the vanes 30 outwards, towards the internal surface 16 of the pump enclosure 10. A contact surface on the tip 32 of each vane 30 is in sliding contact with the internal surface 16. During sliding of the vanes 30 forth and back in the slots 22, an outer surface 34 of the vane 30 is in contact with an inner surface 24 of the slot. The vanes 30 defines separated volumes 9 between the rotating member 20 and the pump enclosure 10.

Upon rotating the rotating member 20, the separated volumes 9 will be moved around within the pump enclosure 10. When a separated volume 9 comes into contact with the inlet 12, the volume 9 is in a phase where the volume increases due to the un-centered position of the rotating member 30 and liquid is sucked from the inlet 12 into the separated volume 9. When the rotation continues and the trailing vane passes the inlet 12, the separated volume 9 is closed. Upon further rotation, the separated volume 9 is transferred towards the outlet 14. When the leading vane passes the outlet 14, and the separated volume 9 successively reduces its volume, the trapped liquid will be pressed out through the outlet 14. In other words, the rotating member 20 is arranged for, when being rotated, causing a transfer of a liquid from the inlet 12 to the outlet 14.

This transfer of liquid is enabled by different internal surfaces, e.g. the outside of the rotating element 20, the internal surface 16 of the pump enclosure and the tip 32 of the vanes 30, exposing each other for a sliding contact. This sliding contact is preferably tight in order to reduce leakage of liquid between the separated volumes 9. Also, the outer surface 34 of the vane 30 is in sliding contact with an inner surface 24 of the slot 22, and wear may occur also here. In other words, the rotary vane pump 2 has internal sliding surfaces that during operation are exposed to the liquid and are exposed to a sliding contact relative to other internal sliding surfaces of the rotary vane pump. Such surfaces are thus exposed for contaminations in the pumped liquid, e.g. soot and are at the same time intended to provide a tight sliding contact.

Another type of rotary positive displacement pumps are rotary screw pumps. A rotary screw pump comprises one or more screws mounted on a rotor or rotating member that rotates within the pump enclosure. The screw of the rotary screw pump has a circumferential surface that is in sliding contact with an internal surface of the pump enclosure. In designs using more than one screw, the surfaces of the threads of the screw may also be in sliding contact with other screws.

FIG. 2 illustrates one embodiment of a rotary screw pump 3, i.e. one type of a rotary positive displacement pump 1. The rotary screw pump 3 comprises a pump enclosure 10, having an inlet 12 and an outlet 14. The rotary screw pump 3 further comprises at least one rotating member 20, in this embodiment two screws. The screws have threads 23 wound in opposite directions, enabling an interaction between the surfaces of the threads 23 and/or shaft of the rotating member 20. One of the screws, in the figure the upper one, is connected to a motor that provides a rotation of the shaft of the rotating member 20. This rotation movement is transferred also to the second screw by means of a gear 42, whereby the lower screw rotated in an opposite direction compared to the upper one. The rotating members 20 are allowed to rotate by bearings 40 connected to the pump enclosure 10.

Liquid is allowed to enter into the inlet 12 and will also fill the volumes between the threads 23 and the internal surface 16 of the pump enclosure 10. Upon rotating the screws, this liquid between the threads 23 will be displaced along the axis of the screws. Due to the sliding contacts between circumferential surfaces 26 of the screw and the sliding contact between the screws, the liquid becomes trapped within separated volumes 9. The rotation of the screws will successively transfer the liquid within these separated volumes along the screw axes towards the outlet 14. In other words, the rotating members 20 are arranged for, when being rotated, causing a transfer of a liquid from the inlet 12 to the outlet 14.

This transfer of liquid is enabled by different internal surfaces, e.g. the circumferential surface 26 or other surfaces of the screws, and the pump enclosure, exposing each other for a sliding contact. This sliding contact is preferably tight in order to reduce leakage of liquid between the separated volumes 9. In other words, the rotary screw pump 3 has internal sliding surfaces that during operation are exposed to the liquid and are exposed to a sliding contact relative to other internal sliding surfaces of the rotary screw pump 3. Such surfaces are thus exposed for contaminations in the pumped liquid, e.g. soot and are at the same time intended to provide a tight sliding contact.

Another type of rotary positive displacement pumps are rotary gear pumps. There are two commonly used variations, usually denoted as rotary external gear pumps and rotary internal gear pumps, respectively.

A rotary external gear pump comprises two external gears, typically spur gears, mounted in such a way that the teeth on the spur gears fits into the valleys between the teeth of the opposite spur gear. This fitting, prohibits any fluid to pass between the gears. By rotating the external gear with a close contact with the internal surface of the pump enclosure, liquid will be transported from one side of the pump to the opposite.

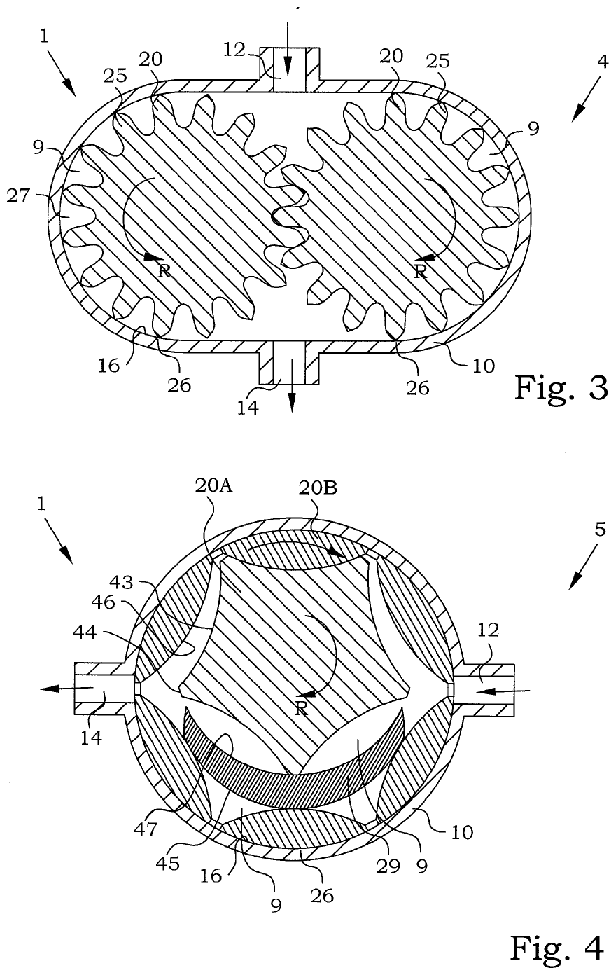

FIG. 3 illustrates one embodiment of a rotary external gear pump 4, i.e. one type of a rotary positive displacement pump 1. The pump enclosure 10 has an inlet 12 and an outlet 14. Two rotating members 20, in the shape of external spur gears are rotatably arranged so that the teeth of one spur gear interact with the opposite spur gear. The two external spur gears are in sliding contact with each other and with an internal surface 26 of the pump enclosure 10. When the gears are rotated, in opposite direction due to the mutual interaction, fluid from the inlet enters into the space between the spur gear teeth. When the gear is rotated and comes into contact with the internal surface 26 of the pump enclosure 10, separated volumes 9 containing fluid are formed. These separated volumes 9 are transferred along the internal surface 26 of the pump enclosure 10 towards the outlet, where the separated volumes 9 are opened up again. Any reflow of fluid between the gears is prevented or at least decreased by the interaction between the gear teeth. In other words, the rotating members 20 are arranged for, when being rotated, causing a transfer of a liquid from the inlet 12 to the outlet 14.

This transfer of liquid is enabled by different internal surfaces, e.g. the top land 25 of the teeth, the internal surface 16 of the pump enclosure 10 and the flanks of the teeth, exposing each other for a sliding contact. This sliding contact is preferably tight in order to reduce leakage of liquid between the separated volumes 9 or any backflow between the gears. In other words, the rotary external gear pump 4 has internal sliding surfaces that during operation are exposed to the liquid and are exposed to a sliding contact relative to other internal sliding surfaces of the rotary external gear pump. Such surfaces are thus exposed for contaminations in the pumped liquid, e.g. soot and are at the same time intended to provide a tight sliding contact.

A rotary internal gear pump comprises two gears, one external gear and one internal gear. The gears are mounted in such a way that the protrusions on the internal gear fits into the valleys of the external gear and protrusions on the external gear fits into the valleys of the internal gear. This fitting prohibits any fluid to pass between the gears. By rotating the external gear and thereby also the internal gear with a close contact with the internal surface of the pump enclosure or a gear separating member, liquid will be transported from one side of the pump to the opposite.

FIG. 4 illustrates one embodiment of a rotary internal gear pump 5, i.e. one type of a rotary positive displacement pump 1. A pump enclosure 10 has an inlet 12 and an outlet 14. There are two rotating members 20A, 20B, one external gear 20A and one internal gear 20B. The rotary internal gear pump 5 thus comprises one external gear 20A and one internal gear 20B that are in sliding contact with each other. The internal gear 20B is in sliding contact with an internal surface 16 of the pump enclosure 10. When the gears are rotated, in the same direction due to the mutual interaction, fluid from the inlet enters into the space between the gear protrusions. When the gears are rotated, they come into contact with a stationary separating member 29, whereby separated volumes 9 containing fluid are formed. These separated volumes 9 are transferred along the separating member 29 towards the outlet, where the separated volumes 9 are opened up again. Any reflow of fluid between the gears is prevented or at least decreased by the direct interaction between the external gear and the internal gear. In other words, the rotating members 20A, 20B are arranged for, when being rotated, causing a transfer of a liquid from the inlet 12 to the outlet 14.

This transfer of liquid is enabled by different internal surfaces, e.g. the internal surface 16 of the pump enclosure 10, the outer surface 26 of the internal gear 20B, the top land 44 of the protrusions of the external gear 20A, an inner surface 47 of the separating member 29, the surface 46 of the inner gear 20B protrusions, an outer surface 45 of the separating member 29 and the surface 43 of the valleys of the external gear 20A, exposing each other for a sliding contact. This sliding contact is preferably tight in order to reduce leakage of liquid between the separated volumes 9 or any backflow between the gears. In other words, the rotary internal gear pump 5 has internal sliding surfaces that during operation are exposed to the liquid and are exposed to a sliding contact relative to other internal sliding surfaces of the rotary internal gear pump 5.

Common for all these types of pumps is that there are sliding contacts between different parts of the pumps that also are in direct contact with the liquid that the pump pumps. In other words, the sliding contacts are exposed for substances being present in the pumped liquid. Since these pumps often are used as vehicle oil pumps, the sliding contacts may be exposed to varying amounts of soot.

There are previous attempts of increasing the wear resistance of these sliding surfaces. Individual benefits of heat treatment processes are well known and application examples are abundant. The ideas behind the heat treatment processes is to give rise to a surface that is hard and thus wear resistant. Another approach to reduce wear is to instead minimize the friction between sliding surfaces. The use of solid lubricant coatings are thus also popular in many applications. See for instance, S. Jacobson, S. Hogmark, Tribologi—friktion, nötning & smörjning, Uppsala, Ångströmslaboratoriet, 5th ed, 2005, p. 70; M. Cartier, T. A. Polak, G. D. Wilcox, Handbook of Surface Treatments and Coatings, Professional Engineering, 2003, pp. 176-197, 279-283.

To meet specific application needs, heat treatment and solid lubricant coatings can also be used together. This allows even better control over friction and wear. As specific non-exclusive examples where this strategy is exercised in the prior art, one could mention application of MoS₂ solid lubricant paste onto a nitrocarburized pipe centralizer, disclosed in the published US patent application US 2016/0002986. Application of solid lubricants, such as PTFE, graphite and MoS₂, onto the surface of a hardened guide member has also been performed. Application of PTFE onto nitrocarburized surface of rotatable components such as CV joints is described in the published US patent application US 2011/0151238. Application of a polymer-bonded solid lubricant coating, also known as friction reducing paint, has been practiced onto a high-pressure fuel pump component. A combination of heat treatment and solid lubricant coatings to increase the wear and corrosion resistance of bearing surfaces subjected to high friction strains is shown in the U.S. Pat. No. 5,753,052. In all the cases described, the application of a solid lubricant coating onto the component surface requires a separate operation, increasing production costs. Also for such combined methods of heat treatment and solid lubricant coatings, the presence of soot still is a problem.

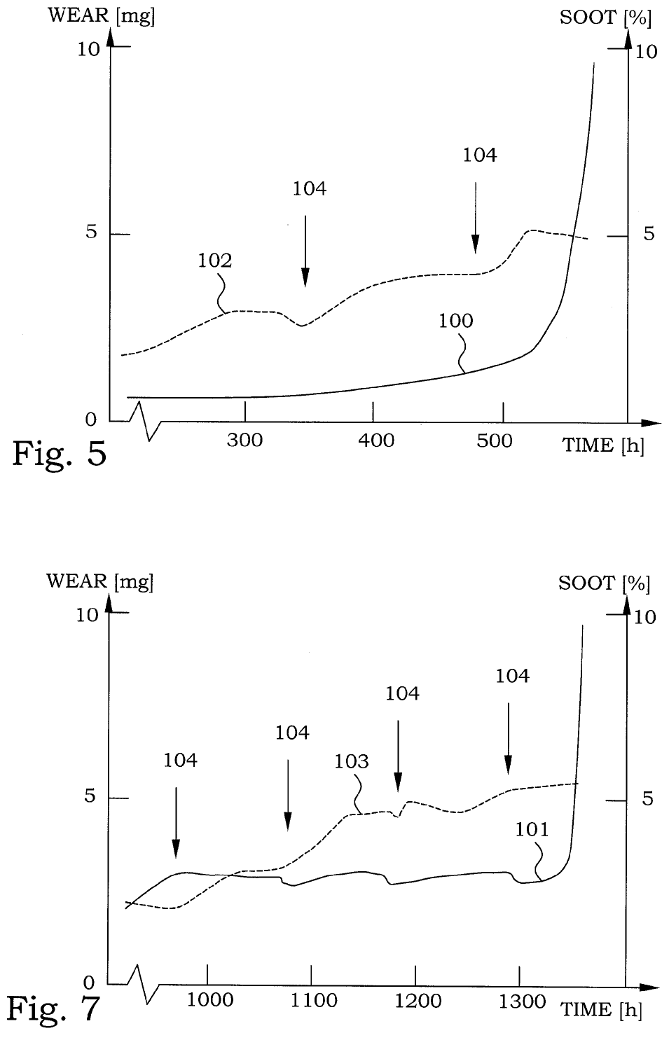

FIG. 5 is a diagram illustrating the wear process of nitrided vanes in a soot-contaminated ACEA C5 motor oil. The amount of wear is measures in mg and is represented by the curve 100. Soot level builds up with time as the engine is running. The soot level is represented by curve 102. Oil is being continuously sampled during the test for soot and wear quantification, and hence needs to be topped-up time to time, as indicated by the arrows 104. From the diagram, it can be concluded that intense wear begins after 550 h of engine operation as soon as soot level reaches 5%. After comparison with wear in soot-free oils, it can be concluded that the soot content plays an important role in causing intense wear, an in particular at high soot levels, in this case over 5%.

The additional treatment of e.g. nitrided vanes with a conventional covering layer of a solid lubricant will improve the situation somewhat. However, a high soot level will also in this case rapidly lead to a high wear rate.

However, it has been found that vanes featuring solid lubricant within the compound layer outperform both DLC coated and nitrided vanes in terms of wear resistance at high soot levels. Such solutions can also be performed in economically favorable production steps.

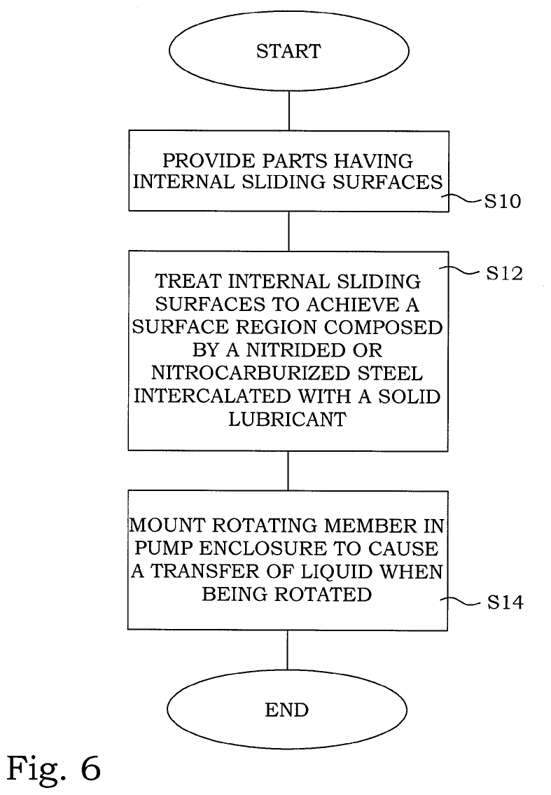

FIG. 6 is a flow diagram of steps of an embodiment of a method for manufacturing a rotary positive displacement pump. In step S10, parts having internal sliding surfaces are provided. In step S12, at least a part of the internal sliding surfaces are treated to achieve a surface region composed by a nitrided or nitrocarburized steel intercalated with a solid lubricant. The internal sliding surfaces can be present on a rotating member and/or a stationary member, e.g. a pump enclosure. In step S14, at least one rotating member is mounted in a pump enclosure. The pump enclosure has an inlet and an outlet. The rotating member is arranged for, when being rotated, causing a transfer of a liquid from the inlet to the outlet. This step is, as such, well known in prior art. The parts that have the internal sliding surfaces are arranged to being exposed to the liquid during operation. The parts that have the internal sliding surfaces are also being exposed to a sliding contact relative to other internal sliding surfaces of the rotary positive displacement pump.

FIG. 7 is a diagram illustrating the wear process of TriboNite® vanes in a soot-contaminated ACEA C5 motor oil. The TriboNite® method will be described further below. The amount of wear is measures in mg and is represented by the curve 101. Soot level builds up with time as the engine is running. The soot level is represented by curve 103. Oil is being continuously sampled during the test for soot and wear quantification, and hence needs to be topped-up time to time, as indicated by the arrows 104. Very low wear rate is observed for over 1300 h even at soot levels exceeding 5%. Intense wear begins only after the entire compound layer is rubbed off. Furthermore, the soot level seems not to be as crucial as for vanes without the TriboNite® treatment. The intercalated solid lubricant in the nitrided or nitrocarburized steel surface region seems to be important for the wear properties.

One preferred method to integrate solid lubricant coating into a heat treatment process, the so-called thermal processing 86 coating technology trademarked as TriboNite®, has been described, as such, in the published International patent application WO2017/078592. Even though it has been proven that TriboNite® technology allows one to effectively boost the tribological performance in suitable applications, the significant improvements in the acceptance of high soot levels were a surprise.

TriboNite® treatment of sliding surfaces for rotary positive displacement pumps thus allows a significantly extended pump service life when soot contaminated oils are used. TriboNite® treatment of extruded steel parts made of 31CrMoV9 or similar alloys leads to the solid lubricant intercalation into the topmost compound layer.

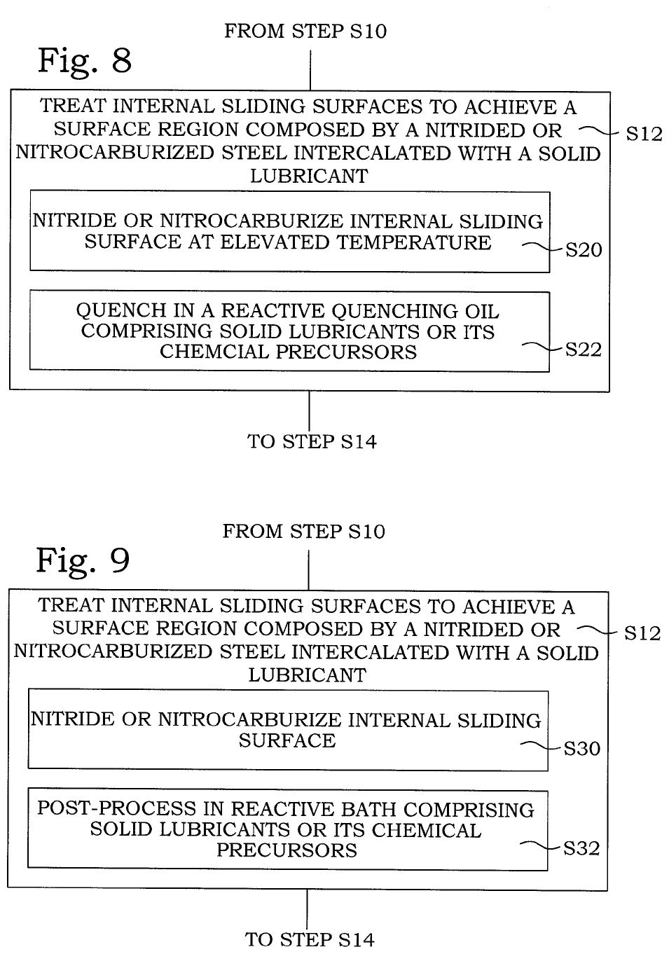

FIG. 8 is a flow diagram of one of the steps of FIG. 6, illustrating an embodiment of a method for manufacturing a rotary positive displacement pump. The step S12 of treating comprises here the part steps S20 and S22. In step S20, the mentioned part of the internal sliding surfaces is nitrided or nitrocarburized at an elevated temperature. This gives rise to a nitrided or nitrocarburized surface region. In step 22, the nitrided or nitrocarburized surface region is quenched in a reactive quenching oil from the elevated temperature. The reactive quenching oil comprises solid lubricants or its chemical precursors.

One additional advantage with the use of the TriboNite® treatment, besides the surprising soot-accepting effect, is that the provision of the intercalated solid lubricant is performed in a same process as the nitriding or nitrocarburizing. This makes the manufacturing efficient and economically attractive.

Another possible solution is to use regular nitrified or nitrocarburized surfaces which were post-processed in a reactive bath containing a solid lubricant or its chemical precursors. From such a reactive bath, deposition of solid lubricants within the pore space of the compound layer is achieved, greatly improving soot-handling characteristics of the pump.

FIG. 9 is a flow diagram of one of the steps of FIG. 6, illustrating an embodiment of a method for manufacturing a rotary positive displacement pump. The step S12 of treating comprises here the part steps S30 and S32. In step 830, the mentioned part of the internal sliding surfaces is nitridedg or nitrocarburized. This gives rise to a nitrided or nitrocarburized surface region. In step S32, the nitrided or nitrocarburized surface region is post-processed in a reactive bath. The reactive bath comprises solid lubricants or its chemical precursors.

As described above, the rotary positive displacement pump can be of different types. However, the above described ideas concerning the intercalated solid lubricants are applicable in all different types.

In case of a rotary vane pump, internal surfaces that are exposed for sliding contacts and that therefore may be of interest to be provided by a nitrided or nitrocarburized surface region intercalated with solid lubricants is e.g. the outside of the rotating element, the internal surface of the pump enclosure and the tip of the vanes. Also the outer surface of the vane is in sliding contact with the inner surface of the slot, and may benefit from such surface regions. The surfaces that normally are exposed for the highest degree of wear are present on parts of the vane, and it is therefore preferred if such parts of the vane presenting such internal sliding surfaces have a surface region with a nitrided or nitrocarburized steel intercalated with a solid lubricant.

In a corresponding manufacturing method, where the rotary positive displacement pump is a rotary vane pump, the step of mounting comprises arranging of at least one vane to enable sliding relative the rotating member and an internal surface of the pump enclosure. Furthermore, the step of treating preferably comprises treating of at least a part of the vane to achieve a surface region composed by a nitrided or nitrocarburized steel intercalated with a solid lubricant.

In case of a rotary screw pump, internal surfaces that are exposed for sliding contacts and that therefore may be of interest to be provided by a nitrided or nitrocarburized surface region intercalated with solid lubricants is e.g. the surfaces of the screws, in particular the circumferential surface, and the internal surface of the pump enclosure. The surfaces that normally are exposed for the highest degree of wear are present on the circumferential surfaces, and it is therefore preferred if these surfaces present a surface region with a nitrided or nitrocarburized steel intercalated with a solid lubricant.

In a corresponding manufacturing method, where the rotary positive displacement pump is a screw pump, the step of mounting comprises arranging of a circumferential surface of a screw, which is the rotating member, in sliding contact with an internal surface of the pump enclosure. Furthermore, step of treating preferably comprises treating of at least a part of the circumferential surface to achieve a surface region composed by a nitrided or nitrocarburized steel intercalated with a solid lubricant.

In case of a rotary external gear pump, internal surfaces that are exposed for sliding contacts and that therefore may be of interest to be provided by a nitrided or nitrocarburized surface region intercalated with solid lubricants is e.g. the top land of the teeth, the internal surface of the pump enclosure and the flanks of the teeth. The surfaces that normally are exposed for the highest degree of wear are present on the gears, and it is therefore preferred if these surfaces present a surface region with a nitrided or nitrocarburized steel intercalated with a solid lubricant.

In a corresponding manufacturing method, where the rotary positive displacement pump is a gear pump, the rotating member is a gear. Also, where the rotary positive displacement pump is an external gear pump, the step of mounting comprises mounting of two external spur gears in sliding contact with each other and in sliding contact with an internal surface of the pump enclosure. Furthermore, the treating preferably comprises treating of at least a part of the gears to achieve a surface region composed by a nitrided or nitrocarburized steel intercalated with a solid lubricant.

In case of a rotary internal gear pump, internal surfaces that are exposed for sliding contacts and that therefore may be of interest to be provided by a nitrided or nitrocarburized surface region intercalated with solid lubricants is e.g. the internal surface of the pump enclosure, the outer surface of the internal gear, the top land of the protrusions of the external gear, an inner surface of the separating member, the surface of the inner gear protrusions, an outer surface of the separating member and the surface of the valleys of the external gear, exposing each other for a sliding contact. The surfaces that normally are exposed for the highest degree of wear are present on the gears, and it is therefore preferred if these surfaces present a surface region with a nitrided or nitrocarburized steel intercalated with a solid lubricant.

In a corresponding manufacturing method, where the rotary positive displacement pump is a gear pump, the rotating member is a gear. Also, where the rotary positive displacement pump is an internal gear pump, the step of mounting comprises mounting of one external gear and one internal gear in sliding contact with each other, and mounting of the internal spur gear in sliding contact with an internal surface of the pump enclosure. Furthermore, the step of treating preferably comprises treating of at least a part of the gear to achieve a surface region composed by a nitrided or nitrocarburized steel intercalated with a solid lubricant.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

1. A rotary positive displacement pump, comprising:
a pump enclosure, having an inlet and an outlet; and
at least one rotating member;
said rotating member being arranged for, when being rotated, causing a transfer of a liquid from said inlet to said outlet;
whereby said rotary positive displacement pump has internal sliding surfaces that during operation being exposed to said liquid and being exposed to a sliding contact relative to other internal sliding surfaces of said rotary positive displacement pump;
wherein at least a part of said internal sliding surfaces has a surface region composed by a nitrided or nitrocarburized steel intercalated with a solid lubricant.

2. The rotary positive displacement pump according to claim 1, wherein said rotary positive displacement pump is a rotary vane pump, wherein said rotary vane pump comprises at least one vane arranged to enable sliding against said rotating member and an internal surface of said pump enclosure.

3. The rotary positive displacement pump according to claim 2, wherein a part of said vane presents said internal sliding surfaces having a surface region with a nitrided or nitrocarburized steel intercalated with a solid lubricant.

4. The rotary positive displacement pump according to claim 1, wherein said rotary positive displacement pump is a screw pump, wherein said rotating member is a screw, a circumferential surface of which being in sliding contact with an internal surface of said pump enclosure.

5. The rotary positive displacement pump according to claim 4, wherein a part of said circumferential surface presents said internal sliding surfaces having a surface region with a nitrided or nitrocarburized steel intercalated with a solid lubricant.

6. The rotary positive displacement pump according to claim 1, wherein said rotary positive displacement pump is a gear pump, wherein said rotating member is a gear.

7. The rotary positive displacement pump according to claim 6, wherein said rotary positive displacement pump is an external gear pump comprising two external gears being in sliding contact with each other and an internal surface of said pump enclosure.

8. The rotary positive displacement pump according to claim 6, wherein said rotary positive displacement pump is an internal gear pump comprising one external gear and one internal gear, being in sliding contact with each other, and wherein said internal gear is in sliding contact with an internal surface of said pump enclosure.

9. The rotary positive displacement pump according to claim 6, wherein a part of said gear presents said internal sliding surfaces having a surface region with a nitrided or nitrocarburized steel intercalated with a solid lubricant.

10. A method for manufacturing a rotary positive displacement pump, comprising the steps of:
providing parts having internal sliding surfaces,
mounting at least one rotating member in a pump enclosure, said pump enclosure having an inlet and an outlet, wherein said rotating member being arranged for, when being rotated, causing a transfer of a liquid from said inlet to said outlet, and wherein said parts having said internal sliding surfaces are arranged to during operation being exposed to said liquid and being exposed to a sliding contact relative to other internal sliding surfaces of said rotary positive displacement pump; and
treating at least a part of said internal sliding surfaces to achieve a surface region composed by a nitrided or nitrocarburized steel intercalated with a solid lubricant.

11. The method according to claim 10, wherein said step of treating comprises the steps of:
nitriding or nitrocarburizing said part of said internal sliding surfaces at an elevated temperature, giving a nitrided or nitrocarburized surface region; and
quenching said nitrided or nitrocarburized surface region in a reactive quenching oil, comprising solid lubricants or its chemical precursors, from said elevated temperature.

12. The method according to claim 10, wherein said step of treating comprises the steps of:
nitriding or nitrocarburizing said part of said internal sliding surfaces, giving a nitrided or nitrocarburized surface region; and
post-processing said nitrided or nitrocarburized surface region in a reactive bath, comprising solid lubricants or its chemical precursors.

13. The method according to claim 10, wherein said rotary positive displacement pump is a rotary vane pump, wherein said step of mounting comprises arranging at least one vane enabling sliding against said rotating member and an internal surface of said pump enclosure.

14. The method according to claim 13, wherein said step of treating comprises treating of at least a part of said vane to achieve a surface region composed by a nitrided or nitrocarburized steel intercalated with a solid lubricant.

15. The method according to claim 10, wherein said rotary positive displacement pump is a screw pump, wherein said step of mounting comprises arranging a circumferential surface of a screw, being said rotating member, in sliding contact with an internal surface of said pump enclosure.

16. The method according to claim 15, wherein said step of treating comprises treating at least a part of said circumferential surface to achieve a surface region composed by a nitrided or nitrocarburized steel intercalated with a solid lubricant.

17. The method according to claim 10, wherein said rotary positive displacement pump is a rotary gear pump, wherein said rotating member is a gear.

18. The method according to claim 17, wherein said rotary positive displacement pump is a rotary external gear pump, wherein said step of mounting comprises mounting of two external gears in sliding contact with each other and in sliding contact with an internal surface of said pump enclosure.

19. The method according to claim 17, wherein said rotary positive displacement pump is an internal gear pump, wherein said step of mounting comprises mounting of one external gear and one internal gear in sliding contact with each other, and mounting said internal gear is in sliding contact with an internal surface of said pump enclosure.

20. The method according to claim 17, wherein said step of treating comprises treating at least a part of said gear to achieve a surface region composed by a nitrided or nitrocarburized steel intercalated with a solid lubricant.
